(19) United States
(12) Patent Application Publication
(10) Pub. No.: US 2023/0413369 A1
(43) Pub. Date: Dec. 21, 2023

(54) HEARTBEAT SYSTEM AND METHOD FOR BROADCAST SYSTEM

(71) Applicant: Trilogy 5G, Inc., Irving, TX (US)

(72) Inventors: Imran Syed, Irving, TX (US); John Vetter, Irving, TX (US)

(73) Assignee: Trilogy 5G, Inc., Irving, TX (US)

(21) Appl. No.: 18/211,855

(22) Filed: Jun. 20, 2023

Related U.S. Application Data
(63) Continuation-in-part of application No. 18/137,655, filed on Apr. 21, 2023.
(60) Provisional application No. 63/353,996, filed on Jun. 21, 2022.

(51) Int. Cl. H04W 76/25; H04H 40/00; H04N 21/24

(52) U.S. Cl. CPC H04W 76/25; H04H 40/00; H04N 21/2402; H04H 2201/11; H04H 2201/37

(57) ABSTRACT

A heartbeat system and signaling protocol for a digital broadcast system that provides a unicast return path signaling protocol. In one embodiment, the digital broadcast system may be an ATSC 3.0 compliant broadcast system.

### PRIORITY CLAIMS/RELATED APPLICATIONS

This patent application claims the benefits under 35 USC 119(e) to U.S. Provisional Patent Application No. 63/353,996, filed Jun. 21, 2022 and priority under 35 USC 120 and is a continuation in part of U.S. patent application Ser. No. 18/137,655 filed Apr. 21, 2023, all of which are incorporated herein by reference.

### FIELD

The disclosure relates to a system and method that provides a heartbeat for a broadcasting system.

### BACKGROUND

The Advanced Television Systems Committee (ATSC) has been promulgating standards for broadcast systems for a long time. A typical broadcasting system is a one-way method of communication and thus cannot receive any signal back from each device/receiver to which the signal is being broadcast. The simplest example of this device/receiver is a television that receives broadcast data and displays that data to the user. As a result, the capabilities of ATSC enabled system are limited, forces broadcasters to trust that the information was received successfully by each receiver and does not allow user interactions with digital services.

ATSC recently promulgated a new standard (ATSC 3.0) that combines the typical broadcast data (the one way broadcasting of the same data to a plurality of devices/receivers for example) with two way digital data, such as provided in the 5G standard. With a system that implements the ATSC 3.0 standard, a single broadcaster can emit a signal that broadcasts high resolution data for a receiver, such as large-screen TV on the wall, at the same time that the system can be broadcast and receive data associated with a mobile device. According to ATSC, the ATSC 3.0 system converges broadcast and broadband, solving some of the problems that even 5G can't solve in the conventional cell provider world and the ATSC 3.0 standard speaks to the Internet of Things (IoT) and to the need for high speed, ultra-reliable lifeline communications for emergency alerts.

With the new ATSC 3.0 standard, a broadcaster can provide digital services to a device/receiver (the downlink) and the device/receiver can communicate back to the broadcaster through a dedicated channel (the unlink) that “supports interactive services in ATSC 3.0 without dependance on other non-ATSC 3.0 network infrastructure ad discussed in the ATSC Standard 3.0 A/323: 2022-03 (Dedicated Return Channel for ATSC 3.0), Section 4 at page 6. Thus, in ATSC 3.0, the dedicated return channel is a part/integrated into the same ATSC 3.0 network infrastructure that limits what can be done with the dedicated return channel and its bandwidth. Furthermore, the dedicated return channel in ATSC 3.0 suffers from the problem that an outage of the ATSC 3.0 network will also take down the dedicated return channel.

A desirable signal returned to the broadcaster from each receiver/device may be a signal indicating that the device has received the digital service(s) and desires to continue to receive the digital services. It is also desirable to provide that uplink signal over a network architecture separate from the ATSC 3.0 network architecture for redundancy and bandwidth reasons. What is needed is a signaling protocol/method that standardizes the communications between the broadcaster and each device in which data is being broadcast to each device/receiver using the ATSC 3.0 network infrastructure and security and handshaking may be performed over a unicast system using a heartbeat system separate from the ATSC 3.0 network architecture, such as a signaling protocol through the internet, and it is to this end that the disclosure is directed.

### BRIEF DESCRIPTION OF THE DRAWINGS

FIG. 1 is an example of a broadcast system that has an out of band return path;

FIG. 2 illustrates the broadcast system that incorporates a heartbeat system; and

FIG. 3 illustrates more details of an exemplary protocol of the heartbeat system shown in FIG. 2.

### DETAILED DESCRIPTION OF ONE OR MORE EMBODIMENTS

The disclosure is particularly applicable to an Advanced Television Systems Committee (ATSC) 3.0 standard broadcast system and a unicast signaling protocol for a heartbeat signal system that is distinct from the ATSC 3.0 network infrastructure and it is in this context that the disclosure will be described. It will be appreciated, however, that the disclosure has broader application since the heartbeat signal and signaling protocol may be used with other existing or yet to be developed broadcast systems and/or protocols such as the 5G Broadcasting or other US or non-US based broadcasting systems and protocols that can benefit from a heartbeat signal. Other standards and broadcasting systems that may be implemented with the heartbeat system may include a Digital Video Broadcasting (DVB) standard based system (used in Europe), an Integrated Services Digital Broadcasting (ISDB) standard based system (used in Japan) and a Digital Terrestrial Multimedia Broadcast (DTMB) standard based system (used in China). Furthermore, although the illustrative example uses at ATSC 3.0 standard system, the heartbeat system may be implemented on systems that utilize future ATSC standards.

In one embodiment, the unicast return path distinct from the ATSC 3.0 network architecture may be a return path via the internet. While a return path can be set up that is separate from the ATSC 3.0 network infrastructure, in order to monetize the spectrum of the broadcaster, the broadcaster will have to show their customers how many receivers/devices at a given time can receive the data they are planning to broadcast. For this purpose, a regular heartbeat or keep alive message may be sent by the receiver/device over the internet (or any other communication medium different from the ATSC 3.0 network infrastructure) to show how many receivers are available and what channels can they receive and at what signal level and quality. In other embodiments of the heartbeat system, the return path over which the heartbeat messages are sent back to the broadcaster may be any other wireless or wired communication path other than the ATSC 3.0 network infrastructure.

In a broadcasting system that has interactive digital services, broadcasters need to know how many users they can reach to make their business cast. Whenever there is a return channel, a signaling method is needed to communicate to the receiver of the user to send a heartbeat message at a predefined interval. The heart beat message may include a user ID of the user. The heartbeat message allows the broadcaster to know how many users it can reach and will help in the business case when leasing the spectrum to show how many subscribers can be reached at the same time.

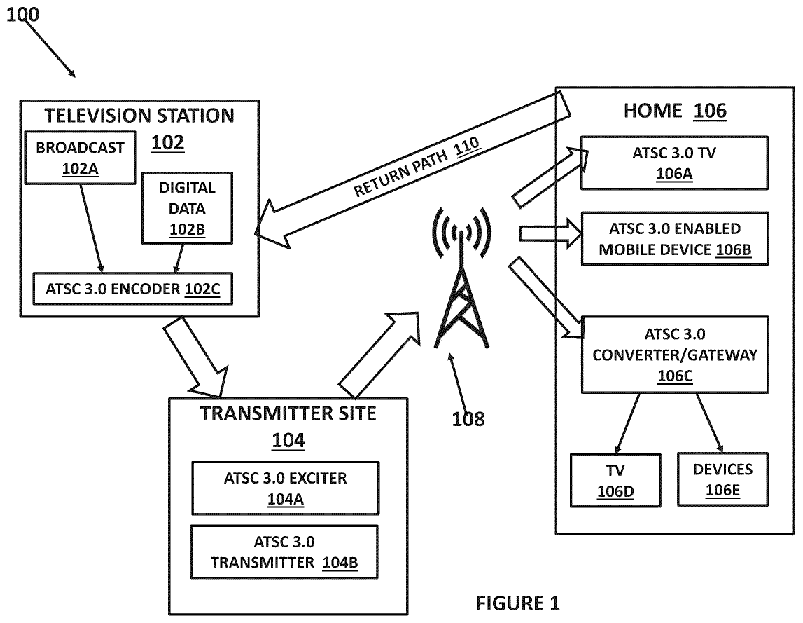

FIG. 1 is an example of a broadcast system 100 that has an out of band return path that can be used as a return channel for digital services that are part of the broadcast system, such as an ATSC 3.0 system. The system 100 may have one or more broadcaster(s) 102, such as one or more television stations, with a single TV station shown in FIG. 1 for clarity, that each send encoded data to a site 104 (that may be a transmitter and/or complimentary SFNs (single frequency network) associated with it or which could be main transmitter or SFN(s)) and send that encoded data using an antenna 108 to a residence 106 that has one or more customer premise devices (CPD)/receivers that consume the encoded data, such as ATSC 3.0 encoded data for an ATSC 3.0 broadcast system. The broadcaster 102 may be a system that comprises of a plurality of server computers that each have at least one processor that executes instructions to perform various operations and processes associated with the broadcaster 102. The broadcaster may have a source of broadcast material 102A, such as a database and database management system, that stores and outputs the content to be broadcast, usually based on a playlist. For example, the piece of content could be a sitcom, sporting event, a news show, advertisements, etc. The broadcaster 102 may also have a digital data system 102B that may store digital data and include and manage the one or more digital services, such as a file transfer, user interaction, etc., being provided by the broadcaster or a third party. The broadcaster may combine the broadcast data and digital data using an encoder 102C, such as an ATSC 3.0 encoder for a broadcast system based on the ATSC 3.0 standard, into a stream of data packets that may be sent to the transmitter site 104.

The transmitter site 104 may be implemented as a plurality of server computers that each have at least one processor that executes instructions to perform various operations and processes associated with the transmitter site 104. For example, the transmitter site 104 may have an ATSC 3.0 exciter 104A that generates the signals that are sent to the antenna 108 by a transmitter 104B.

The residence/company/building 16 may receive the broadcast data from the broadcaster 102 that may include the broadcast data and data for the digital services. The broadcast data may be sent to the various data consuming customer devices/receivers, such as a ATSC 3.0 enabled TV 106A, an ATSC 3.0 enabled mobile device 106B (that may be a tablet computer, a personal computer, a smartphone device, etc.) and an ATSC 3.0 television receiver/converter/gateway 106C that may allow consumer devices that are not compliant with ATSC 3.0 to function with the ATSC 3.0 data. For example, the converter 106C may allow a TV 106D or other devices 106E to still consume the broadcast data and/or digital services in the broadcast. More broadly, each device 106A-E may have a processor, memory, a display and an interface to receive the ATSC 3.0 signal so that each device can consume the data. An example of the device 106E may be a set top box, a zbox, an appliance, a piece of hospital equipment or devices not in a property, such as an automobile or farm equipment, that would benefit from being able to broadcast data, such as firmware updates, software or software updates, from a broadcaster and receive an acknowledgment of the receipt of the digital data by the device.

The system may also have an out of band return path 110 that provides the device(s) in the residence/business/building 106 with a path to send data back to the broadcaster, such as a television station, or third parties that provide the digital services. Unlike the ATSC 3.0 standard that envisions an in-band return channel that may be technically infeasible for the reasons above, the system provide an out of band return path 110. For example, in one use case, the return path may be used for acknowledgments in digital services, such as acknowledgments (ACKs) during a file transfer digital service. The return path 100 may carry ACKs along with any pertinent information, signal quality, file size, date/time, etc. using for example the ATSC 3.0 Datacasting or Multicasting method allowed in ATSC 3.0 protocol. The return path 110 may be any path back using direct internet access (DIA) most likely to assigned IP address(es) of the digital service provider from the connected end user/customer device(s) 106A-106E, For example, the return path 110 may be wireline (FTTx, DSL, Cable, ethernet) and/or wireless (Cellular, PCS, AWS, EBS, CBRS, television whitespace (TVWS), FWA (Fixed Wireless Access), LTE, 5G, future 3GPP standards, pLTE, standard wireless, proprietary licensed or unlicensed spectrum, microwave, satellite, WiFi, SCADA, LoRaWan, IoT, Cellular Modem, Industry 4.0, Bluetooth and/or Zigbee).

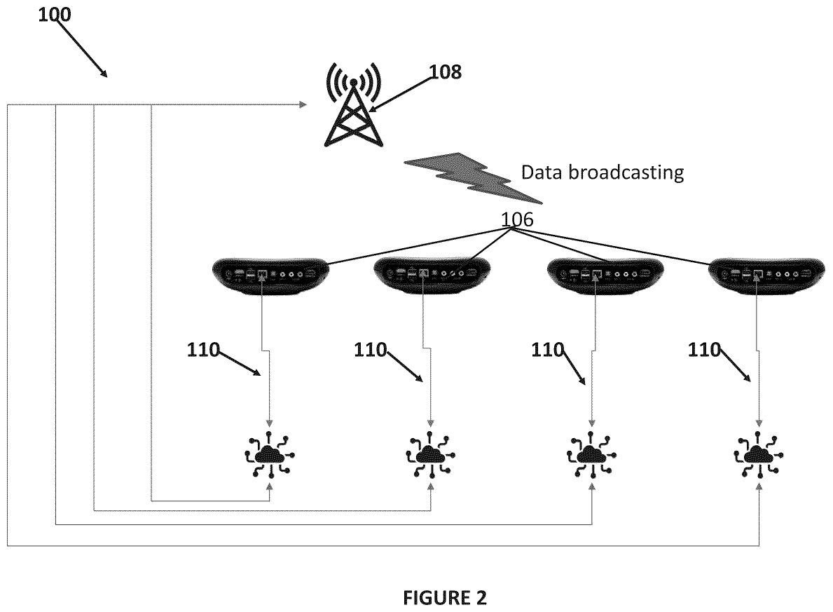

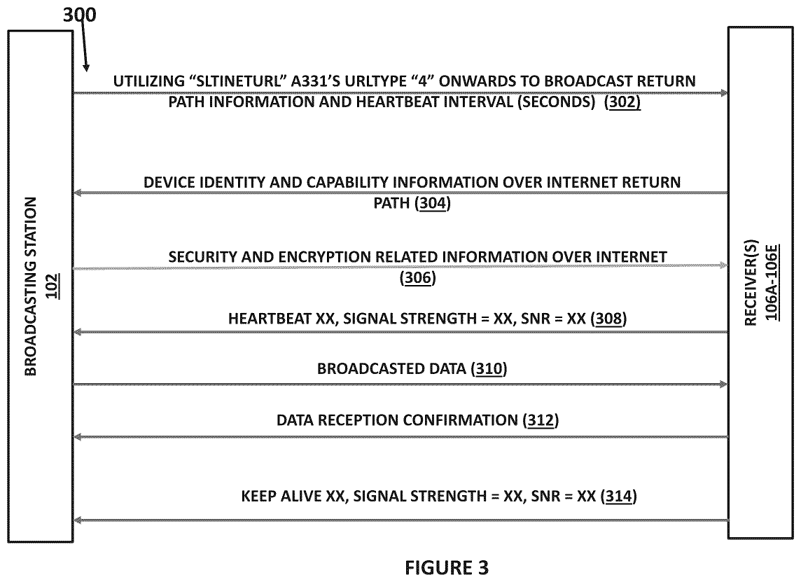

FIG. 2 illustrates the broadcast system 100 that incorporates a heartbeat system and the return path 110. The broadcast antenna 108 may broadcast data to each device 106A-E in each residence/company/building. Each device 106A-E may have the return path 110 by which each device 106A-106E can communicate back to the broadcaster. As discussed above, the return path may be implemented using various technologies and each device 106A-106E may have one or more different return paths 110 that may be used. In one embodiment, the return path 110 may be provided over the Internet. Each return path 110 may communicate a heartbeat/keep alive message from each device 106A-E back to the broadcaster on a periodic basis. Furthermore, each return path 110 may have a signaling protocol to communicate acknowledgments or other types of data back to the broadcaster as is now described with reference to FIG. 3.

FIG. 3 illustrates more details of an exemplary signaling protocol 300 of the heartbeat system shown in FIG. 2 between the broadcast station 102 and each device/receiver 106A-106E. For example, the signaling protocol may be used for a keep alive message, for acknowledgments during a digital data transfer from broadcaster or for acknowledgments during a firmware upgrade of a plurality of devices. For a heartbeat system being implemented using the ATSC 3.0 architecture, the signaling protocol may utilize the ATSC 3.0 A331 standard “service list tables (SLT) SLTNETURL” URLTYPE 4 protocol for signaling as detailed in the ATSC 3.0 A331 standard. For the heartbeat system and the heartbeat protocol, an SLT instance broadcasts/sends information to each device 106A-106E (302) including return path information for the heartbeat data and a heartbeat duration parameter that sets up each device 106A-E for the heartbeat messaging protocol (the heartbeat set-up messaging). The heartbeat duration parameter may set a heartbeat interval (in seconds) for each device so that the heartbeat interval is adjustable and flexible. In response to the heartbeat setup messaging, each device 106A-E may return, via the return path, specified in the heartbeat setup messaging, for the device 106A-106E, an identity of the device and a set of one or more capabilities of the device 106A-106E. (304) The device identity of each device may be, for example, the unique MAC address of the device and optional subscriber information. The set of capabilities of each device may include, for example, a number of tuners in the device, a type of internet connection of the device (e.g., WiFi, Ethernet, SIM, cellular wireless, etc.) and/or the security capabilities of the device (for example, whether or not the device can receive and decrypt messages using a public key, etc.) The device identity of each device allows the system to uniquely identify each device when exchanging messages and the set of one or more capabilities may be used by the broadcaster to configure the data being sent to each device based on those capabilities. At this point, the messaging protocol between the broadcaster and a particular device has been established.

Once the device identity and capabilities are received (and the heartbeat signaling protocol is set up for the device), the broadcaster 102 may send a security setup message (security and encryption information) via the return path to each device (306). The security setup message ensures that the subsequent communications are protected and may include, for example, the device ID, an encryption key for the broadcaster and an expiry time for the encryption key since the encryption key changes periodically to enhance security.

While each device 106A-E is connected/communicating with the broadcaster 102, the device 106A-106E (based in part of the heartbeat duration parameter already exchanged) periodically sends keep alive data or a heartbeat message. Each exchanged heartbeat message may, in one embodiment, have its own identification (Heartbeat XX), an RF channel being used for the particular heartbeat message (RF channel XX), a signal strength data (signal strength −XX dB) and a signal to noise ratio (SNR) data (SNR=XX) for the particular heartbeat message (308). In one embodiment, each device/receiver has known circuits that measure and determine signal strength and signal to noise ratio. The keep alive data allows the broadcaster 102 to determine that each device 106A-E is active and functioning. The signal strength data and SNR data of the device 106A-E may be used by the broadcaster 102 to assess the quality of the broadcasted signal to the particular device 106A-106E. The consequence of poor signal strength or signal to noise ratio is that the particular device may not be in range to receive the broadcasted signal/data. The heartbeat message ID allows the broadcaster to associate each particular heartbeat message with a particular device and thus the signal strength and SNR with that particular device and allows the broadcaster to know which and how many devices are online and can receive the broadcasted signal for successful delivery of data.

The signal strength and SNR values from each device 106A-106E (as well as other quality metrics captured/measured by the device 106A-106E) also may be used to improve and/or optimize the networks between the device 106A-106E and the broadcaster. In particular, the knowledge of the network characteristics as seen by each device 106A-106E may be fed back to the broadcaster and the broadcaster can adjust the network characteristics or change networks to optimize the network performance. This allows the broadcaster to receive real time network characteristic data using the heartbeat system and optimize the network in known ways to address any network issues or deficiencies.

Based in part on the signal strength data and signal to noise ratio (SNR) data for the return path for the device, the broadcaster 102 broadcasts data to the device 106A-106E (310) wherein the data may include, for example, a file transfer, a software download, a firmware update (such as for a car or piece of farm equipment) and the like. More broadly, the broadcast data can be any type of data that it is desirable to broadcast to a plurality of different devices at the same time while providing the unicast return path for a bilateral communication between the broadcaster and the device. Using the device identity exchanged previously, the device may determine the broadcast data for the device and receive it. Once the broadcast data is received successfully by the particular device, the particular device 106A-106E may use the return path to send a data reception confirmation signal back to the broadcaster 102 (312). As an illustrative example, the broadcast data may be a file transfer sent to the device 106A-106E and the reception confirmation signal may be a confirmation of the receipt of the transferred file without any errors.

Once the particular data transfer is completed for the particular device, the device may continue to periodically send its keep alive/heartbeat message to the broadcaster that has the same characteristics and protocol as described above (314). Thus, the broadcaster will know which and how many devices are connected/communicating at all times even when no data transfer is occurring.

The foregoing description, for purpose of explanation, has been with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include and/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general-purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software, and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

What is claimed is:

1. A system, comprising:
a plurality of devices that are each capable of consuming a piece of content broadcast from a digital broadcast system;
the digital broadcast system having a processor and memory wherein the processor executes a plurality of instructions that cause the processor of the digital broadcast system to:
send, from the digital broadcast system, a return path and heartbeat duration request to each device;
receive, by the digital broadcast system from each device, a device identity and a set of device capabilities; and
receive, by the broadcast system from each device based on the heartbeat duration request, a keepalive message.

2. The system of claim 1, wherein the keepalive message further comprises an identifier of the device, a signal strength of the return path for the device, a signal to noise ratio for the return path of the device.

3. The system of claim 2, wherein the processor is further caused to broadcast data to each device and receive, by the digital broadcast system from each device over the return path for each device, a unicast data receipt confirmation message indicated successful receipt of the broadcasted data.

4. The system of claim 1, wherein the processor is further caused to broadcast a security setup message to each device that includes an encryption key.

5. The system of claim 1, wherein the digital broadcast system is an Advanced Television Systems Committee (ATSC) 3.0 system.

6. The system of claim 1, wherein each device has a processor that executes a plurality of lines of instructions so that the processor is configured to one of send an acknowledgement of a file transfer from the digital broadcast system using the keepalive message and send an acknowledgement of a firmware update using the keepalive message.

7. A signaling method between a digital broadcast system and a device that consumes the data from the digital broadcast system, the method comprising:
sending, from a digital broadcast system, a return path and heartbeat duration request to each device that is capable of consuming a piece of content from the digital broadcast system;
receiving, by the digital broadcast system from the device, a device identity and a set of device capabilities; and
receiving, by the digital broadcast system from each device based on the heartbeat duration request, a keepalive message.

8. The method of claim 7, wherein the keepalive message further comprises an identifier of the device, a signal strength of the return path for the device, a signal to noise ratio for the return path of the device.

9. The method of claim 8 further comprising broadcasting data, by the digital broadcast system, to each device and receiving, by the digital broadcast system from each device over the return path for each device, a unicast data receipt confirmation message indicated successful receipt of the broadcasted data.

10. The method of claim 7 further comprising broadcasting by the digital broadcast system a security setup message to each device that includes an encryption key.

11. The method of claim 7, wherein the digital broadcast system is an Advanced Television Systems Committee (ATSC) 3.0 system.

12. The method of claim 7, wherein the keepalive message one of an acknowledgement of a file transfer from the digital broadcast system and an acknowledgement of a firmware update.
